(19) United States
(12) Patent Application Publication
(10) Pub. No.: US 2023/0019687 A1
(43) Pub. Date: Jan. 19, 2023

(54) SERVER DEVICE AND METHOD THEREFOR

(71) Applicant: TOSHIBA TEC KABUSHIKI KAISHA, Tokyo (JP)

(72) Inventor: Tatsuhiko Amano, Numazu Shizuoka (JP)

(21) Appl. No.: 17/715,132

(22) Filed: Apr. 7, 2022

(30) Foreign Application Priority Data
Jul. 19, 2021 (JP) 2021-118472

(51) Int. Cl. G06Q 20/40; G06Q 20/32; G01S 11/06; G01S 1/04

(52) U.S. Cl. CPC G06Q 20/4014; G06Q 20/3223; G06Q 20/3278; G01S 11/06; G01S 1/0428

(57) ABSTRACT

A server device includes: a first receiver to receive, from a settlement terminal, settlement identification information for identifying a settlement method by which the settlement terminal makes a settlement, and portable terminal identification information for identifying portable terminals located within a predetermined distance, the portable terminal identification information being included in a radio wave sent out, and intensity information representing a radio wave intensity of the radio wave received by the settlement terminal; a correlation unit to correlate the portable terminal identification information corresponding to the intensity information of the highest radio wave intensity received by the first receiver, with the settlement identification information; a memory controller to store, in a memory, settlement record information that correlates the settlement identification information with the portable terminal identification information; and an estimation unit to estimate a settlement method used on a per portable terminal basis, based on pieces of the settlement record information stored in the memory.

### CROSS-REFERENCE TO RELATED APPLICATION

This application is based upon and claims the benefit of priority from Japanese Patent Application No. 2021-118472, filed on Jul. 19, 2021, the entire contents of which are incorporated herein by reference.

### FIELD

Embodiments described herein relate generally to a server device and a method therefor.

### BACKGROUND

According to the related art, a store such as a supermarket causes a user such as a customer visiting the store to install a dedicated application on the user's portable terminal, and transmits and displays information corresponding to the user on the portable terminal.

However, a user who is concerned about the protection of personal information dislikes installing a dedicated application on the portable terminal. Therefore, widespread use of the service of providing information corresponding to the user from the store or the like is hard to achieve.

### DESCRIPTION OF THE DRAWINGS

FIG. 1 shows an example of a notification system according to an embodiment.

FIG. 2 is a graph showing the distance from a beacon and the intensity of a radio wave from the beacon.

FIG. 3 is a block diagram showing an example of a hardware configuration of a management server.

FIG. 4 is a block diagram showing an example of the hardware configuration of a signage terminal.

FIG. 5 is a block diagram showing an example of the hardware configuration of a settlement terminal.

FIG. 6 is a functional block diagram showing an example of a functional configuration of each device of a notification system.

FIG. 7 is an explanatory view showing an example of a guide screen.

FIG. 8 is an explanatory view showing an example of a suggestion screen.

FIG. 9 is a flowchart showing an example of recording processing executed by the settlement terminal.

FIG. 10 is a flowchart showing an example of estimation processing executed by a management server.

### DETAILED DESCRIPTION

An embodiment described herein is to provide a server device and a method therefor that can facilitate the provision of information corresponding to the user.

In general, according to one embodiment, a server device includes: a first receiving unit configured to receive, from a settlement terminal, settlement identification information for identifying a settlement method by which the settlement terminal makes a settlement, and portable terminal identification information for identifying each of one or a plurality of portable terminals located within a predetermined distance from the settlement terminal, the portable terminal identification information being included in a radio wave sent out from the one or plurality of portable terminals, and intensity information representing a radio wave intensity of the radio wave received by the settlement terminal; a correlation unit configured to correlate the portable terminal identification information corresponding to the intensity information of the highest radio wave intensity received by the first receiving unit, with the settlement identification information; a memory control unit configured to store, in a memory unit, settlement record information that correlates the settlement identification information with the portable terminal identification information; an estimation unit configured to estimate a settlement method used on a per portable terminal basis, based on a plurality of pieces of the settlement record information stored in the memory unit; and a transmission unit configured to transmit the settlement method estimated by the estimation unit.

An embodiment of the server device and the method therefor will now be described with reference to the accompanying drawings. The embodiment described below is one embodiment of the server device and the method therefor. The configurations and the functions or the like in the embodiment should not limit the present disclosure.

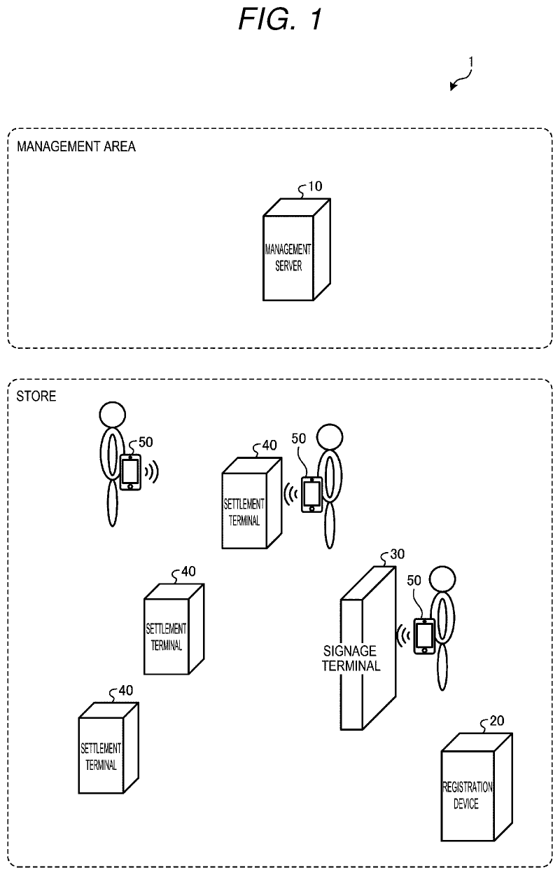

FIG. 1 shows an example of a notification system 1 according to this embodiment. The notification system 1 is a system that gives a notification of a settlement method that is likely to be used by a customer at a store such as a retail store. The notification system 1 has a management server 10 (an example of the server device), a registration device 20, a signage terminal 30, and a settlement terminal 40. The management server 10 is arranged in a management area (for example, a backroom of the store) where a manager of the notification system 1 is stationed. The registration device 20, the signage terminal 30, and the settlement terminal 40 are arranged in the store. In the store, the settlement terminal 40 is provided on a per settlement method basis. The settlement method is a method of specifying a type of settlement and making a settlement. The settlement method includes, for example, a method of settlement by cash, a method of settlement by credit card, and a contactless settlement method or the like.

The management server 10, the registration device 20, the signage terminal 30, and the settlement terminal 40 are connected communicatively with each other by wired or wireless communication. The configuration of the notification system 1 shown in FIG. 1 is an example. The notification system 1 may have any number of the above devices. The signage terminal 30 and the settlement terminal 40 are connected to a portable terminal 50 carried by a customer via short-range wireless communication and can transmit and receive data and information.

The portable terminal 50 is a terminal that can be carried, such as a smartphone or a tablet terminal. The portable terminal 50 transmits portable terminal identification information for identifying the portable terminal 50 by short-range wireless communication such as Bluetooth (registered trademark). The portable terminal identification information of the portable terminal 50 is, for example, a public address of Bluetooth (registered trademark) device address, a Bluetooth (registered trademark) MAC (media access control) address, or the like. For example, the portable terminal 50 sends out a beacon (radio wave) including the portable terminal identification information.

The output value of the beacon sent out by the portable terminal 50 is prescribed to a predetermined value (for example, 25 mW) by the standard. Therefore, the beacon that is sent out reaches a range of approximately 5 meters by 5 meters from the portable terminal 50 but does not reach beyond that range as its radio wave is damped.

The registration device 20 is a device that executes merchandise registration processing in which a target merchandise to be sold in the store is registered. For example, the registration device 20 is a device such as a POS (point of sales) terminal. The registration device 20 transmits merchandise registration information representing the merchandise registered by the merchandise registration processing.

The signage terminal 30 is a display device that displays various kinds of information to the customer. The signage terminal 30 is an example of a first device. The signage terminal 30 receives the portable terminal identification information from the portable terminal 50 if the portable terminal 50 entered a reception range where the portable terminal 50 can communicate with the signage terminal 30 by short-range wireless communication. For example, the reception range is a range of 5 meters from the signage terminal 30. The reception range may be changed freely.

The signage terminal 30 specifies the customer viewing the signage terminal 30, based on the portable terminal identification information received from the portable terminal 50. In the store shown in FIG. 1, the settlement terminal 40 is provided on a per settlement method basis. The signage terminal 30 displays a screen guiding the customer to the settlement terminal 40 corresponding to a settlement method estimated to be used by the customer.

The settlement terminal 40 is a payment device that executes settlement processing in which the price of the merchandise specified by the merchandise registration processing is paid. The settlement terminal 40 is an example of a second device. That is, the settlement terminal 40 executes the settlement processing, based on the merchandise registration information resulting from the merchandise registration processing by the registration device 20. For example, the settlement terminal 40 is a device such as a POS terminal. The settlement terminal 40 receives the beacon (radio wave) including the portable terminal identification information from the portable terminal 50 if the portable terminal 50 entered a reception range where the portable terminal 50 can communicate with the settlement terminal 40 by short-range wireless communication. Since the output value of the beacon is prescribed, for example, the beacon reception range is a range of 5 meters from the settlement terminal 40, as in the case of the signage terminal 30. The radio wave intensity of the beacon received by the settlement terminal 40 becomes higher as the distance between the settlement terminal 40 and the portable terminal 50 becomes shorter. The radio wave intensity of the beacon received by the settlement terminal 40 becomes lower as the distance between the settlement terminal 40 and the portable terminal 50 becomes longer.

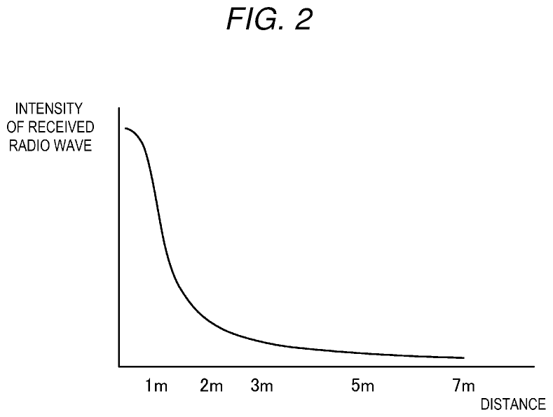

FIG. 2 is a graph showing the relationship between the radio wave intensity of the beacon received by the settlement terminal 40 from the portable terminal 50 and the distance between the settlement terminal 40 and the portable terminal 50. If the distance between the settlement terminal 40 and the portable terminal 50 is shorter than 1 meter (for example, 3 centimeters to several tens of centimeters), the settlement terminal 40 receives the beacon with a relatively high radio wave intensity. However, if the distance between the settlement terminal 40 and the portable terminal 50 is approximately 1 meter or longer, the radio wave intensity of the beacon received by the settlement terminal 40 suddenly drops. This means that the radio wave intensity of the beacon reaching the settlement terminal 40 is suddenly damped if the portable terminal 50 is spaced apart from the settlement terminal 40 by several tens of centimeters or more.

For example, if the customer carries out an action of holding the portable terminal 50 over a predetermined position on the settlement terminal 40, the distance between the settlement terminal 40 and the portable terminal 50 is within several tens of centimeters and therefore the settlement terminal 40 receives the beacon with a high radio wave intensity. However, the distance between the portable terminal 50 carried by a passerby near the settlement terminal 40 and the settlement terminal 40 is not within several tens of centimeters and therefore the settlement terminal 40 does not receive the beacon from this portable terminal 50 with a high radio wave intensity. That is, the radio wave intensity of the beacon received by the settlement terminal 40 from the portable terminal 50 of the customer making a settlement at the settlement terminal 40 is higher than the radio wave intensity of the beacon received from the portable terminal 50 carried by another customer located within 5 meters. That is, the radio wave intensity of the beacon received from the portable terminal 50 of the customer making the settlement at the settlement terminal 40 is the highest. Since the customer making the settlement is located at the nearest position to the settlement terminal 40, the settlement terminal 40 receives the beacon with the highest radio wave intensity from the portable terminal 50 carried by the customer making the settlement even if the customer does not carry out the action of holding the portable terminal 50 over the settlement terminal 40. The settlement terminal 40 transmits settlement identification information representing the settlement method processed by the settlement terminal 40, and the portable terminal identification information of the portable terminal 50 carried by the customer making the settlement and intensity information representing the radio wave intensity.

The reception ranges of the settlement terminal 40 and the signage terminal 30 may differ in size from each other. The reception ranges may be changed freely.

The settlement terminal 40 specifies the customer using the settlement terminal 40, based on the portable terminal identification information included in the received beacon. The settlement terminal 40 displays a settlement method estimated to be used by the customer. The customer selects a desired settlement method from the displayed settlement methods.

If settlement processing for a merchandise is executed by the selected settlement method, the settlement terminal 40 transmits, to the management server 10, the settlement identification information for identifying the settlement method, and the portable terminal identification information and the intensity information representing the radio wave intensity of the received beacon corresponding to the portable terminal identification information (for example, information representing the intensity of the received radio wave in the form of a numeric value). If a plurality of customers are present around the settlement terminal 40 at the time of settlement, that is, if a plurality of portable terminals 50 exist in the reception range of the settlement terminal 40, the settlement terminal 40 receives the portable terminal identification information from each of the plurality of portable terminals 50. In this case, the settlement terminal 40 transmits, to the management server 10, the settlement identification information, and a plurality of pieces of portable terminal identification information and intensity information corresponding to each piece of portable terminal identification information. In other words, on executing the settlement processing, the settlement terminal 40 transmits the portable terminal identification information and the intensity information of the portable terminal 50 held by the customer present in the reception range of the settlement terminal 40, and the settlement identification information representing the settlement method.

The management server 10 is a server device such as a personal computer or a cloud computing server. The management server 10 is not limited to one server device and may be formed by a plurality of server devices. If the management server 10 received the settlement identification information and one or more pieces of portable terminal identification information and intensity information from the settlement terminal 40, the management server 10 correlates the settlement identification information with one piece of portable terminal identification information having the highest radio wave intensity and thus stores these pieces of information.

If the management server 10 received an estimation request that requests estimation of a settlement method for the customer holding the portable terminal 50 specified by the portable terminal identification information, the management server 10 estimates a settlement method for the customer, based on the stored information. The management server 10 then transmits the estimated settlement method to the signage terminal 30 and the settlement terminal 40. Thus, the signage terminal 30 and the settlement terminal 40 display information about the settlement method estimated to be used by the customer.

The hardware configurations of the various devices provided in the notification system 1 will now be described.

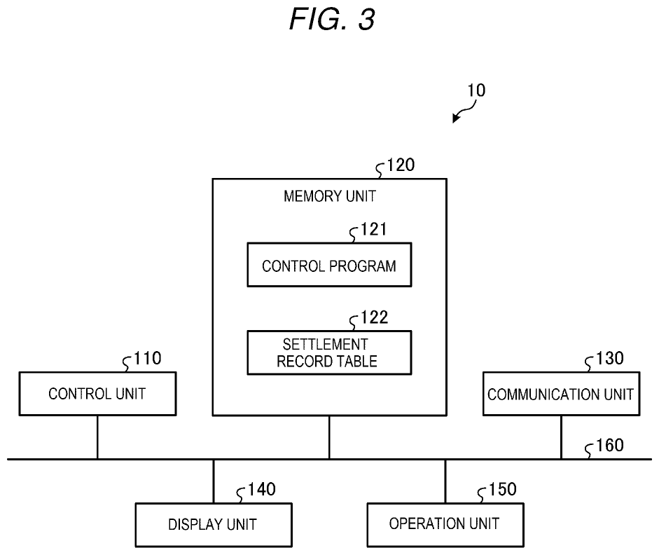

FIG. 3 is a block diagram showing an example of the hardware configuration of the management server 10. The management server 10 has a control unit 110, a memory unit 120, a communication unit 130, a display unit 140, and an operation unit 150. These units are connected to each other via a system bus 160 such as a data bus or an address bus.

The control unit 110 is a computer controlling the operations of the entirety of the management server 10 and implementing various functions of the management server 10. The control unit 110 has a CPU (central processing unit), a ROM (read-only memory), and a RAM (random-access memory). The CPU comprehensively controls the operations of the management server 10. The ROM is a memory medium storing various programs and data. The RAM is a memory medium temporarily storing various programs and various data. The CPU executes the programs stored in the ROM or the memory unit 120 or the like, using the RAM as a work area.

The memory unit 120 is a memory device such as an HDD (hard disk drive) or an SSD (solid-state drive). The memory unit 120 stores a control program 121 and a settlement record table 122. The settlement record table 122 may be stored not only in the management server 10 but also in another device.

The control program 121 is an operating system or a program for implementing the functions of the management server 10. The control program 121 includes a program for implementing characteristic functions according to this embodiment.

The settlement record table 122 is an information table in which settlement identification information representing a settlement method executed by the settlement terminal 40 and information about the portable terminal 50 existing around the settlement terminal 40 at the time of settlement are registered. More specifically, the settlement record table 122 correlates the settlement identification information with one piece of portable terminal identification information having the highest radio wave intensity and thus stores these pieces of information.

The communication unit 130 is an interface executing communication with an external device. For example, the communication unit 130 executes communication with the signage terminal 30 and the settlement terminal 40.

The display unit 140 is a display device displaying various screens. For example, the display unit 140 is a liquid crystal display.

The operation unit 150 is an input device accepting various operations, such as a keyboard or a mouse.

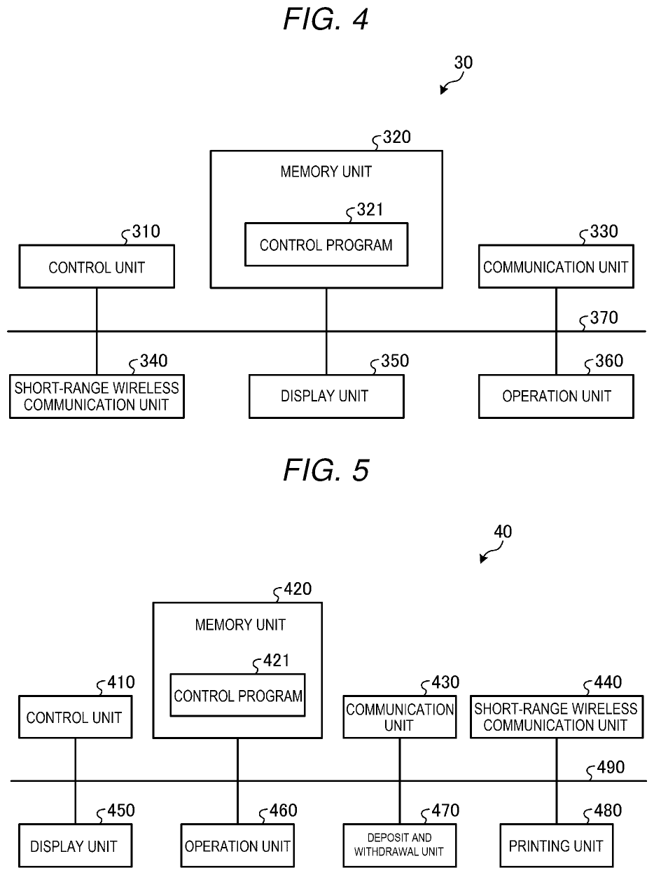

FIG. 4 is a block diagram showing an example of a hardware configuration of the signage terminal 30. The signage terminal 30 has a control unit 310, a memory unit 320, a communication unit 330, a short-range wireless communication unit 340, a display unit 350, and an operation unit 360. These units are connected to each other via a system bus 370 such as a data bus or an address bus.

The control unit 310 is a computer controlling the operations of the entirety of the signage terminal 30 and implementing various functions of the signage terminal 30. The control unit 310 has a CPU, a ROM, and a RAM. The CPU comprehensively controls the operations of the signage terminal 30. The ROM is a memory medium storing various programs and data. The RAM is a memory medium temporarily storing various programs and various data. The CPU executes the programs stored in the ROM or the memory unit 320 or the like, using the RAM as a work area.

The memory unit 320 is a memory device such as an HDD or an SSD. The memory unit 320 stores a control program 321. The control program 321 is an operating system or a program for implementing the functions of the signage terminal 30. The control program 321 includes a program for implementing characteristic functions according to this embodiment.

The communication unit 330 is an interface executing communication with an external device. For example, the communication unit 330 executes communication with the management server 10.

The short-range wireless communication unit 340 executes communication with the portable terminal 50 by short-range wireless communication such as Bluetooth (registered trademark). For example, the short-range wireless communication unit 340 receives a beacon (radio wave) including the portable terminal identification information from the portable terminal 50.

The display unit 350 is a display device displaying various screens. For example, the display unit 350 is a liquid crystal display.

The operation unit 360 is an input device accepting various operations. For example, the operation unit 360 is a touch pad provided at the display unit 350, or a hardware button or the like.

FIG. 5 is a block diagram showing an example of the hardware configuration of the settlement terminal 40. The settlement terminal 40 has a control unit 410, a memory unit 420, a communication unit 430, a short-range wireless communication unit 440, a display unit 450, an operation unit 460, a deposit and withdrawal unit 470, and a printing unit 480. These units are connected to each other via a system bus 490 such as a data bus or an address bus.

The control unit 410 is a computer controlling the operations of the entirety of the settlement terminal 40 and implementing various functions of the settlement terminal 40. The control unit 410 has a CPU, a ROM, and a RAM. The CPU comprehensively controls the operations of the settlement terminal 40. The ROM is a memory medium storing various programs and data. The RAM is a memory medium temporarily storing various programs and various data. The CPU executes the programs stored in the ROM or the memory unit 420 or the like, using the RAM as a work area.

The memory unit 420 is a memory device such as an HDD or an SSD. The memory unit 420 stores a control program 421. The control program 421 is an operating system or a program for implementing the functions of the settlement terminal 40. The control program 421 includes a program for implementing characteristic functions according to this embodiment.

The communication unit 430 is an interface executing communication with an external device. For example, the communication unit 430 executes communication with the management server 10 and the registration device 20.

The short-range wireless communication unit 440 executes communication with the portable terminal 50 by short-range wireless communication such as Bluetooth (registered trademark). For example, the short-range wireless communication unit 440 receives a beacon (radio wave) including the portable terminal identification information from the portable terminal 50. The control unit 410 measures the radio wave intensity of the received beacon and generates intensity information representing this radio wave intensity.

The display unit 450 is a display device displaying various screens. For example, the display unit 450 is a liquid crystal display.

The operation unit 460 is an input device accepting various operations. For example, the operation unit 460 is a touch pad provided at the display unit 450, or a hardware button or the like.

The deposit and withdrawal unit 470 is an automatic change dispenser executing deposit and withdrawal of money if settlement processing is executed using a method of settlement by cash. The deposit and withdrawal unit 470 contains money such as coins and banknotes inputted from a deposit port into a container unit. The deposit and withdrawal unit 470 also outputs money such as coins and banknotes as change to a withdrawal port from the container unit.

The printing unit 480 is a printer printing various kinds of information. For example, the printing unit 480 prints a receipt.

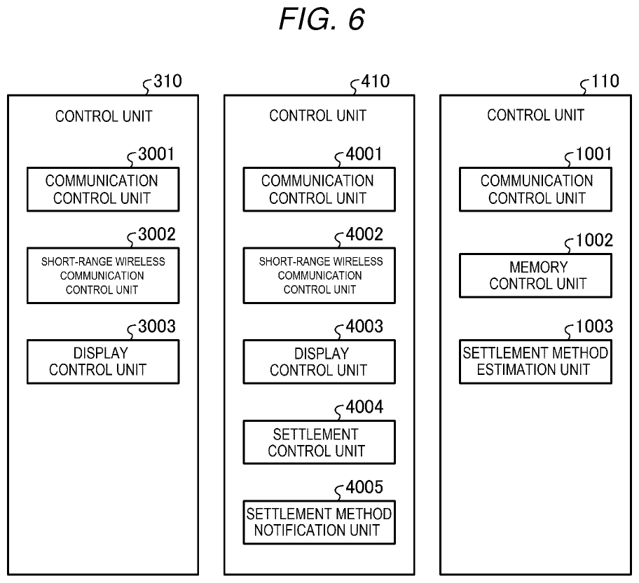

The functions of each device in the notification system 1 will now be described. FIG. 6 is a functional block diagram showing an example of the functional configuration of each device in the notification system 1.

The CPU of the control unit 310 of the signage terminal 30 loads the control program 321 stored in the memory unit 320 into the RAM, then operates according to the control program 321, and thus generates each functional unit in the RAM. Thus, the control unit 310 of the signage terminal 30 has, as its functional units, a communication control unit 3001, a short-range wireless communication control unit 3002, and a display control unit 3003.

The communication control unit 3001 controls the communication unit 330 to execute communication with the management server 10. For example, the communication control unit 3001 transmits, to the management server 10, an estimation request that requests estimation of a settlement method for the customer carrying the portable terminal 50 specified by the portable terminal identification information. The estimation request includes the portable terminal identification information specifying the portable terminal 50 that is a target of estimation. The communication control unit 3001 receives estimation result information representing the settlement method estimated in response to the estimation request, as a response to the estimation request from the management server 10.

The short-range wireless communication control unit 3002 controls the short-range wireless communication unit 340 to receive, from the portable terminal 50, the portable terminal identification information specifying (identifying) this portable terminal 50. More specifically, if the portable terminal 50 entered the reception range where the portable terminal 50 can communicate with the signage terminal 30 by short-range wireless communication, the short-range wireless communication control unit 3002 receives the portable terminal identification information from this portable terminal 50.

The display control unit 3003 controls the display unit 350 to display various screens. If the short-range wireless communication control unit 3002 received the portable terminal identification information, the display control unit 3003 causes the communication control unit 3001 to transmit the estimation request including the received portable terminal identification information. For example, the display control unit 3003 may cause the estimation request to be transmitted every time the short-range wireless communication control unit 3002 receives the portable terminal identification information. Also, the display control unit 3003 may cause the estimation request to be transmitted every time a predetermined time passes. Also, the display control unit 3003 may cause the estimation request to be transmitted if the operation unit 360 accepted an operation. The display control unit 3003 may cause the estimation request to be transmitted at a timing other than these.

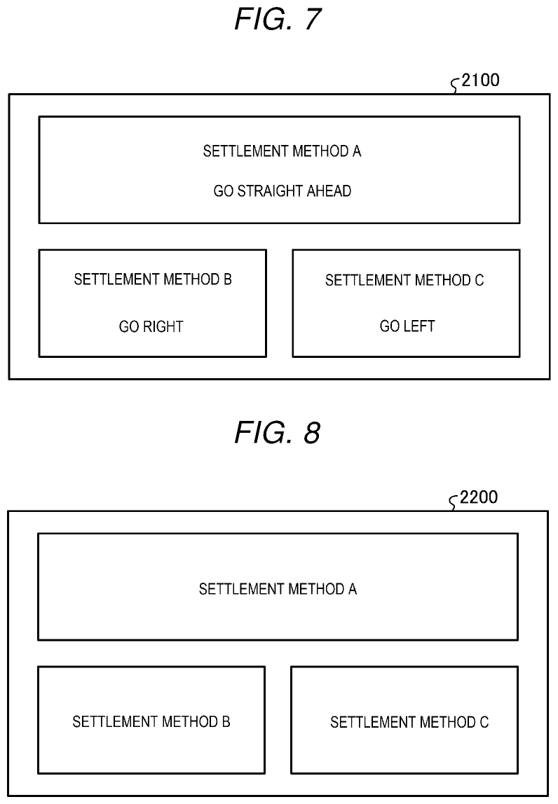

If the communication control unit 3001 received the estimation result information, the display control unit 3003 causes a guide screen 2100 to be displayed, based on the estimation result information. FIG. 7 is an explanatory view showing an example of the guide screen 2100. The guide screen 2100 is a screen guiding to the place where the settlement terminal 40 is installed, on a per settlement method basis. The estimation result information includes one or more pieces of settlement method information representing a settlement method estimated to be used. For each of the one or more pieces of settlement method information, a probability value at which the settlement method is used is set. The display control unit 3003 causes the guide screen 2100 to be displayed, based on the probability value of the one or more pieces of settlement method information included in the estimation result information. For example, the display control unit 3003 displays a settlement method, adjusting the size according to the estimated probability value of the settlement method, on the guide screen 2100. The guide screen 2100 shown in FIG. 7 shows a state where the estimated probability value of a settlement method A is 50 percent, the estimated probability value of a settlement method B is 25 percent, and the estimated probability value of a settlement method C is 25 percent. That is, the display control unit 3003 displays a guide to the settlement terminal 40 suitable for the settlement method A, in a large size, and displays guides to the settlement terminals 40 suitable for the settlement methods B and C, in a smaller size than for the settlement terminal 40 suitable for the settlement method A. The guide screen 2100 shown in FIG. 7 displays three settlement methods. However, any number of settlement methods may be displayed on the guide screen 2100 in order from the settlement method with the highest estimated probability value. Also, the number of settlement methods may be changed.

The CPU of the control unit 410 of the settlement terminal 40 loads the control program 421 stored in the memory unit 420 into the RAM, then operates according to the control program 421, and thus generates each functional unit in the RAM. Thus, the control unit 410 of the settlement terminal 40 has, as its functional units, a communication control unit 4001, a short-range wireless communication control unit 4002, a display control unit 4003, a settlement control unit 4004, and a settlement method notification unit 4005.

The communication control unit 4001 controls the communication unit 430 to execute communication with the management server 10. For example, the communication control unit 4001 transmits, to the management server 10, an estimation request that requests estimation of a settlement method for the customer carrying the portable terminal 50 specified by the portable terminal identification information. The communication control unit 4001 also receives estimation result information representing the settlement method estimated in response to the estimation request, as a response to the estimation request from the management server 10.

If a settlement is executed, the communication control unit 4001 transmits, to the management server 10, settlement identification information representing the settlement method (type of settlement) of the executed settlement, and one or more pieces of portable terminal identification information received at the time of the settlement and intensity information representing the radio wave intensity of the received radio wave, along with a record request that requests that these pieces of information should be stored. The communication control unit 4001 may separately transmit the settlement identification information, and the one or more pieces of portable terminal identification information and the intensity information, to the management server 10, instead of the record request correlating the settlement identification information with the one or more pieces of portable terminal identification information. In this case, the time when the settlement identification information is acquired, and the time when the one or more pieces of portable terminal identification information and the intensity information are acquired, are transmitted. Thus, the management server 10 can correlate the settlement identification information with the one or more pieces of portable terminal identification information and the intensity information.

The short-range wireless communication control unit 4002 controls the short-range wireless communication unit 440 to receive the portable terminal identification information from the portable terminal 50. More specifically, if the portable terminal 50 entered the reception range where the portable terminal 50 can communicate with the settlement terminal 40 by short-range wireless communication, the short-range wireless communication control unit 4002 receives the portable terminal identification information from this portable terminal 50. The short-range wireless communication control unit 4002 also causes the memory unit 420 or the like to store the received portable terminal identification information.

If the short-range wireless communication control unit 4002 received the portable terminal identification information, the communication control unit 4001 measures the radio wave intensity of each piece of portable terminal identification information that is received, generates intensity information representing this radio wave intensity, and correlates the intensity information with each piece of portable terminal identification information.

The display control unit 4003 controls the display unit 450 to display various screens. The display control unit 4003 also causes the communication control unit 4001 to transmit the estimation request including the received portable terminal identification information. For example, the display control unit 4003 may cause the estimation request to be transmitted every time the short-range wireless communication control unit 4002 receives the portable terminal identification information. Also, the display control unit 4003 may cause the estimation request to be transmitted if the operation unit 460 accepted an operation. The display control unit 4003 may cause the estimation request to be transmitted at a timing other than these.

If the communication control unit 4001 received the estimation result information, the display control unit 4003 causes a suggestion screen 2200 showing a settlement method to be displayed, based on the estimation result information. FIG. 8 is an explanatory view showing an example of the suggestion screen 2200. The suggestion screen 2200 is a screen providing a settlement method. The display control unit 4003 causes the suggestion screen 2200 to be displayed, based on one or more settlement methods and the probability value of each settlement method included in the estimation result information. For example, the display control unit 4003 displays a settlement method, adjusting the size according to the probability value on the suggestion screen 2200. The suggestion screen 2200 shown in FIG. 8 shows a state where the probability value of a settlement method A is 50 percent, the probability value of a settlement method B is 25 percent, and the probability value of a settlement method C is 25 percent. That is, the display control unit 4003 displays the settlement method A in a large size and displays the settlement methods B and C in a smaller size than the settlement method A. The suggestion screen 2200 shown in FIG. 8 displays three settlement methods. However, the number of settlement methods displayed on the suggestion screen 2200 may be changed freely.

The settlement control unit 4004 executes settlement processing in which the price of a merchandise registered by merchandise registration processing by the registration device 20 is paid. More specifically, the settlement control unit 4004 accepts an operation of acquiring merchandise registration information representing the merchandise registered by the merchandise registration processing. For example, the settlement control unit 4004 accepts an operation of inputting identification information representing the merchandise registration information. If the settlement control unit 4004 has a reading device such as a scanner, the settlement control unit 4004 may cause the reading device to read a two-dimensional code issued by the registration device 20 and including the merchandise registration information of the merchandise registered by the merchandise registration processing and thus acquire the merchandise registration information. The settlement control unit 4004 then executes the settlement processing for the payment of the price of the merchandise included in the merchandise registration information. For example, the settlement control unit 4004 executes the settlement processing by the settlement method selected on the suggestion screen 2200.

If the settlement control unit 4004 executed the settlement processing, the settlement method notification unit 4005 causes the communication control unit 4001 to transmit a record request. More specifically, if the settlement control unit 4004 executed the settlement processing, the settlement method notification unit 4005 specifies the portable terminal identification information received by the short-range wireless communication control unit 4002 at the time of the settlement. The time of the settlement specifying the portable terminal identification information is not limited to the same as the time of the settlement but may be within a predetermined time period from the time when the settlement is made. For example, the settlement method notification unit 4005 may specify portable terminal identification information included in a beacon received within a set time period around the time when the settlement is made, as the portable terminal identification information received at the time of the settlement. The settlement method notification unit 4005 then causes the communication control unit 4001 to transmit a record request that includes the settlement identification information representing the settlement method for the settlement executed by the settlement control unit 4004 and that also includes one or a plurality of pieces of portable terminal identification information received by the short-range wireless communication control unit 4002 at the time of the settlement and the intensity information on a per portable terminal identification information basis.

The CPU of the control unit 110 of the management server 10 loads the control program 121 stored in the memory unit 120 into the RAM, then operates according to the control program 121, and thus generates each functional unit in the RAM. Thus, the control unit 110 of the management server 10 has, as its functional units, a communication control unit 1001, a memory control unit 1002, and a settlement method estimation unit 1003.

The communication control unit 1001 controls the communication unit 130 to execute communication with the signage terminal 30 or the settlement terminal 40. The communication control unit 1001 receives an estimation request that requests estimation of a settlement method for the customer having the portable terminal 50 specified by the portable terminal identification information. The communication control unit 1001 is an example of a second receiving unit. For example, the communication control unit 1001 receives the estimation request from the signage terminal 30 or the settlement terminal 40.

On receiving the estimation request, the communication control unit 1001 transmits, as a response, estimation result information having the result of the estimation of a settlement method estimated to be used by the customer having the portable terminal 50 specified by the portable terminal identification information included in the estimation request. The communication control unit 1001 transmits the result of the estimation by the settlement method estimation unit 1003. The communication control unit 1001 is an example of a transmission unit. For example, the communication control unit 1001 transmits the result of the estimation by the settlement method estimation unit 1003 to the signage terminal 30 or the settlement terminal 40.

The communication control unit 1001 also receives the settlement identification information for identifying the settlement method, and the portable terminal identification information for identifying the portable terminal 50 and the intensity information. The communication control unit 1001 is an example of a first receiving unit. That is, the communication control unit 1001 receives a record request that includes the settlement identification information and that also includes one or more pieces of portable terminal identification information and the intensity information on a per portable terminal identification information basis, from the settlement terminal 40.

The memory control unit 1002 selects the portable terminal identification information included in the beacon having the highest radio wave intensity, based on the portable terminal identification information and the intensity information received as the record request. The memory control unit 1002 correlates the one selected piece of portable terminal identification information with the received settlement identification information. That is, the memory control unit 1002 correlates the settlement identification information with the one piece of portable terminal identification information included in the beacon having the highest radio wave intensity. The memory control unit 1002 is an example of a correlation unit. The memory control unit 1002 stores settlement record information correlating the settlement identification information with the one piece of portable terminal identification information, in the memory unit 120. The memory control unit 1002 is an example of a memory control unit. More specifically, if the communication control unit 1001 received the record request including the settlement identification information and one or more pieces of portable terminal identification information, the memory control unit 1002 stores the settlement record information correlating the settlement identification information included in the record request with the one selected piece of portable terminal identification information, into the settlement record table 122. If the settlement identification information, and the one or more pieces of portable terminal identification information and the intensity information, are received separately, the memory control unit 1002 stores the settlement record information correlating the settlement identification information with the one selected piece of portable terminal identification information, into the settlement record table 122, based on the settlement identification information, and the portable terminal identification information and the intensity information received within a set time period around the time of settlement when the settlement corresponding to the settlement identification information is executed.

The settlement method estimation unit 1003 estimates a settlement method frequently used on a per portable terminal 50 basis and the probability thereof, based on a plurality of pieces of settlement record information stored in the memory unit 120. The settlement method estimation unit 1003 is an example of an estimation unit. That is, the settlement method estimation unit 1003 estimates a settlement method that is to be used by the customer having the portable terminal 50 that is the target of the estimation request received by the communication control unit 1001.

In many cases, a customer makes a settlement by a particular settlement method which the customer wants to use. For example, a certain customer often makes a settlement using a desired credit card. For example, if the customer forgot to bring the credit card, the customer makes a settlement by a different settlement method. In this way, the customer tends to make a settlement by a particular settlement method that is determined to a certain extent. In the case of the above customer, the proportion at which (or the number of times) the customer makes a settlement by credit card is higher than the proportion at which (or the number of times) the customer makes a settlement by another medium. Therefore, the settlement record information correlated with the portable terminal identification information by the memory control unit 1002 tends to be mostly about the settlement record information according to the particular settlement method on a per portable terminal identification information basis (that is, on a per customer basis). That is, the portable terminal identification information stored in the settlement record table 122 tends to be correlated with the portable terminal identification information specifying the settlement method which the customer wants to use (which the customer always uses). The settlement method estimation unit 1003 estimates the settlement method corresponding to the customer, using such a tendency.

The settlement method estimation unit 1003 estimates a settlement method, based on the number of pieces of settlement identification information correlated with the portable terminal identification information indicating the portable terminal 50 that is the target of the estimation request, in the settlement record information in the settlement record table 122. That is, the settlement method estimation unit 1003 estimates a settlement method, based on the proportion of the settlement identification information correlated with the portable terminal identification information included in the estimation request, in the settlement record information in the settlement record table 122. In other words, the settlement method estimation unit 1003 estimates that a settlement method corresponding to a larger number of pieces (higher proportion) of settlement identification information correlated with this portable terminal identification information is a settlement method that is more probable to be executed by the portable terminal 50 specified by this portable terminal identification information.

Specifically, on receiving the estimation request from the signage terminal 30 or the settlement terminal 40, the settlement method estimation unit 1003 searches for all the pieces of settlement identification information stored and correlated with the portable terminal identification information included in the received estimation request, in the memory unit 120 (specifically, the settlement record table 122), based on this portable terminal identification information, and estimates a settlement method corresponding to a large number of pieces of settlement identification information (for example, three types of settlement identification information from the largest number), of the settlement identification information correlated with the portable terminal identification information, as a settlement method to be used by the customer specified by this portable terminal identification information.

On estimating the settlement method, the settlement method estimation unit 1003 causes the communication control unit 1001 to transmit estimation result information including the estimated settlement method. The estimation result information includes the proportion (probability value) at which a settlement is made in the past by each of the estimated settlement methods. The probability value becomes higher as the number of pieces of correlated settlement identification information becomes greater. The estimation result information is not limited to the probability value and may include information representing high-ranking settlement methods with a high probability of use, the ranking of settlement methods according to the probability of use, or information other than these.

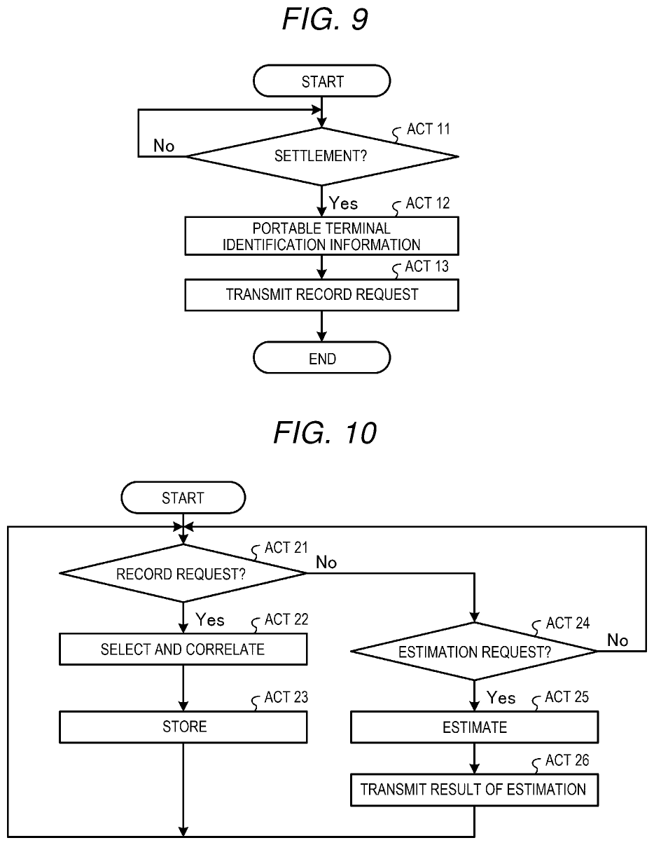

Recording processing executed by the settlement terminal 40 will now be described. FIG. 9 is a flowchart showing an example of the recording processing executed by the settlement terminal 40 in this embodiment.

The settlement control unit 4004 determines whether settlement processing was executed or not (ACT 11).

If the settlement processing was not executed (NO in ACT 11), the settlement control unit 4004 waits in ACT 11.

If it is determined that the settlement processing was executed (YES in ACT 11), the settlement method notification unit 4005 specifies all the portable terminal identification information received at the time of the settlement processing (ACT 12).

The settlement method notification unit 4005 transmits, to the management server 10, a record request that includes the settlement identification information representing the settlement method of the executed settlement processing and that also includes the specified portable terminal identification information and the intensity information (ACT 13).

The settlement terminal 40 then ends the recording processing.

Estimation processing executed by the management server 10 will now be described. FIG. 10 is a flowchart showing an example of the estimation processing executed by the management server 10 in this embodiment.

The communication control unit 1001 determines whether a record request was received or not (ACT 21).

If the record request was received (YES in ACT 21), the memory control unit 1002 selects the portable terminal identification information with the highest radio wave intensity from among the received portable terminal identification information and correlates the selected portable terminal identification information with the received settlement identification information (ACT 22). Next, the memory control unit 1002 stores the settlement record information, which is the settlement identification information and the portable terminal identification information correlated with each other, in the memory unit 120 (more accurately, in the settlement record table 122 (ACT 23).

If the record request was not received (NO in ACT 21), the communication control unit 1001 determines whether an estimation request was received or not (ACT 24). If the estimation request was not received (NO in ACT 24), the communication control unit 1001 shifts to ACT 21.

If it is determined that the estimation request was received (YES in ACT 24), the settlement method estimation unit 1003 estimates a settlement method that is to be used by the customer carrying the portable terminal 50 corresponding to the portable terminal identification information included in the estimation request (ACT 25).

The communication control unit 1001 transmits the result of the estimation to the signage terminal 30 or the settlement terminal 40 that transmitted the estimation request (ACT 26).

The management server 10 then shifts to ACT 21.

As described above, the management server 10 according to the embodiment includes: the communication control unit 1001 (first receiving unit) configured to receive, from the settlement terminal 40, settlement identification information for identifying a settlement method by which the settlement terminal 40 makes a settlement, and portable terminal identification information for identifying each of one or a plurality of portable terminals 50 located within a predetermined distance from the settlement terminal 40, the portable terminal identification information being included in a radio wave sent out from the one or plurality of portable terminals 50, and intensity information representing a radio wave intensity of the radio wave received by the settlement terminal 40; the memory control unit 1002 (correlation unit) configured to correlate the portable terminal identification information corresponding to the intensity information of the highest radio wave intensity received by the communication control unit 1001, with the settlement identification information; the memory control unit 1002 (memory control unit) configured to store, in the memory unit 120, settlement record information that correlates the settlement identification information with the portable terminal identification information; the settlement method estimation unit 1003 (estimation unit) configured to estimate a settlement method used on a per portable terminal 50 basis, based on a plurality of pieces of the settlement record information stored in the memory unit 120; and the communication control unit 1001 (transmission unit) configured to transmit the settlement method estimated by the settlement method estimation unit 1003.

In the management server 10 according to the embodiment as described above, the received settlement identification information is correlated and stored with the portable terminal identification information having the highest radio wave intensity. The management server 10 estimates and transmits a settlement method based on the received portable terminal identification information, in response to the estimation request. The user, who is a customer, can receives the provision of information about the estimated settlement method. That is, the management server 10 can provide information corresponding to the user even if a dedicated application is not installed in the user's portable terminal 50.

While certain embodiments have been described, this embodiment is presented simply as an example and is not intended to limit the scope of the present inventions. This novel embodiment can be carried out in various other forms and can include various omissions, replacements, and modifications without departing from the spirit and scope of the present inventions. This embodiment and the modifications thereof are included in the spirit and scope of the present inventions and also included in the scope of the claims and equivalents thereof.

For example, in the embodiment, the registration device 20 and the settlement terminal 40 are described as separate devices. However, this is not limiting. For example, a single device executing the merchandise registration processing by the registration device 20 and the settlement processing by the settlement terminal 40 may be employed.

It is assumed that the program executed by each device in the embodiment is incorporated in advance in a memory medium (ROM or memory unit) in each device and provided in this form. However, this is not limiting. For example, the program may be recorded as a file in an installable format or an executable format in a computer-readable recording medium such as a CD-ROM, a flexible disk (FD), a CD-R or a DVD (digital versatile disk), and provided in this form. Also, the memory medium is not limited to a medium independent of a computer or an embedded system and also includes a memory medium in which the program transmitted via a LAN (local area network), the internet or the like is downloaded and stored or temporarily stored.

The program executed by each device in the embodiment may be stored on a computer connected to a network such as the internet and may be downloaded via the network and thus provided, or may be provided or distributed via a network such as the internet.

What is claimed is:

1. A server device, comprising:
a first receiving component configured to receive, from a settlement terminal, settlement identification information for identifying a settlement method by which the settlement terminal makes a settlement, and portable terminal identification information for identifying each of one or a plurality of portable terminals located within a predetermined distance from the settlement terminal, the portable terminal identification information being included in a radio wave sent out from the one or plurality of portable terminals, and intensity information representing a radio wave intensity of the radio wave received by the settlement terminal;
a correlation component configured to correlate the portable terminal identification information corresponding to the intensity information of a highest radio wave intensity received by the first receiving component, with the settlement identification information;
a memory controller configured to store, in a memory component, settlement record information that correlates the settlement identification information with the portable terminal identification information;
an estimation component configured to estimate a settlement method used on a per portable terminal basis, based on a plurality of pieces of the settlement record information stored in the memory component; and
a transmission component configured to transmit the settlement method estimated by the estimation component.

2. The server device according to claim 1, further comprising:
a second receiving component configured to receive an estimation request that requests estimation of a settlement method for a customer holding the portable terminal specified by the portable terminal identification information, wherein
the estimation component estimates the settlement method used by the customer holding the portable terminal, based on the portable terminal identification information included in the estimation request received by the second receiving component, and
the transmission component transmits the settlement method estimated by the estimation component.

3. The server device according to claim 2, wherein
the second receiving component receives the estimation request from a first device that displays a guide screen guiding to a place where the settlement terminal corresponding to the settlement method is located, and
the transmission component transmits the settlement method estimated by the estimation unit to the first device.

4. The server device according to claim 2, wherein
the second receiving component receives the estimation request from a second device that displays a suggestion screen providing the settlement method, and
the transmission component transmits the settlement method estimated by the estimation component to the second device.

5. The server device according to claim 2, wherein
the estimation component estimates the settlement method, based on a number of pieces of the settlement identification information correlated with the portable terminal identification information representing the portable terminal that is a target of the estimation request, in the settlement record information.

6. The server device according to claim 1, wherein
the settlement method comprises at least one of a cash settlement, a credit card settlement, and a contactless settlement.

7. The server device according to claim 1, further comprising:
a display configured to display information about the settlement method estimated.

8. A method for a server device, the method comprising:
receiving, from a settlement terminal, settlement identification information for identifying a settlement method by which the settlement terminal makes a settlement, and portable terminal identification information for identifying each of one or a plurality of portable terminals located within a predetermined distance from the settlement terminal, the portable terminal identification information being included in a radio wave sent out from the one or plurality of portable terminals, and intensity information representing a radio wave intensity of the radio wave received by the settlement terminal;
correlating the portable terminal identification information corresponding to the received intensity information of a highest radio wave intensity with the settlement identification information;
storing, in a memory component, settlement record information that correlates the settlement identification information with the portable terminal identification information;
estimating a settlement method used on a per portable terminal basis, based on a plurality of pieces of the settlement record information stored in the memory component; and
transmitting the estimated settlement method.

9. The method according to claim 8, further comprising:
receiving an estimation request that requests estimation of a settlement method for a customer holding the portable terminal specified by the portable terminal identification information;
estimating the settlement method used by the customer holding the portable terminal, based on the portable terminal identification information included in the estimation request received; and
transmitting the settlement method estimated.

10. The method according to claim 9, further comprising:
receiving the estimation request from a first device that displays a guide screen guiding to a place where the settlement terminal corresponding to the settlement method is located; and
transmitting the settlement method estimated to the first device.

11. The method according to claim 9, further comprising:
receiving the estimation request from a second device that displays a suggestion screen providing the settlement method; and
transmitting the settlement method estimated to the second device.

12. The method according to claim 9, further comprising:
estimating the settlement method, based on a number of pieces of the settlement identification information correlated with the portable terminal identification information representing the portable terminal that is a target of the estimation request, in the settlement record information.

13. The method according to claim 8, further comprising:
displaying information about the settlement method estimated.

14. A settlement notification system, comprising:
a plurality of settlement terminals;
a registration device; and
a management server, comprising:
a first receiving component configured to receive, from a settlement terminal, settlement identification information for identifying a settlement method by which the settlement terminal makes a settlement, and portable terminal identification information for identifying each of a plurality of portable terminals located within a predetermined distance from the settlement terminal, the portable terminal identification information being included in a radio wave sent out from the one or plurality of portable terminals, and intensity information representing a radio wave intensity of the radio wave received by the settlement terminal;
a correlation component configured to correlate the portable terminal identification information corresponding to the intensity information of a highest radio wave intensity received by the first receiving component, with the settlement identification information;
a memory controller configured to store, in a memory component, settlement record information that correlates the settlement identification information with the portable terminal identification information;
an estimation component configured to estimate a settlement method used on a per portable terminal basis, based on a plurality of pieces of the settlement record information stored in the memory component; and
a transmission component configured to transmit the settlement method estimated by the estimation component.

15. The settlement notification system according to claim 14, further comprising:
a second receiving component configured to receive an estimation request that requests estimation of a settlement method for a customer holding the portable terminal specified by the portable terminal identification information, wherein
the estimation component estimates the settlement method used by the customer holding the portable terminal, based on the portable terminal identification information included in the estimation request received by the second receiving component, and
the transmission component transmits the settlement method estimated by the estimation component.

16. The settlement notification system according to claim 15, wherein
the second receiving component receives the estimation request from a first device that displays a guide screen guiding to a place where the settlement terminal corresponding to the settlement method is located, and
the transmission component transmits the settlement method estimated by the estimation unit to the first device.

17. The settlement notification system according to claim 15, wherein
the second receiving component receives the estimation request from a second device that displays a suggestion screen providing the settlement method, and
the transmission component transmits the settlement method estimated by the estimation component to the second device.

18. The settlement notification system according to claim 15, wherein
the estimation component estimates the settlement method, based on a number of pieces of the settlement identification information correlated with the portable terminal identification information representing the portable terminal that is a target of the estimation request, in the settlement record information.

19. The settlement notification system according to claim 14, wherein
the settlement method comprises at least one of a cash settlement, a credit card settlement, and a contactless settlement.

20. The settlement notification system according to claim 14, further comprising:
a display configured to display information about the settlement method estimated.
